(19) United States
(12) Patent Application Publication
(10) Pub. No.: US 2005/0202179 A1
(43) Pub. Date: Sep. 15, 2005

(54) Method for using an ethoxylated alkyl phosphate ester additive as a plugmaker processing aid

(76) Inventors: Leo Paul Voegtli, Blountville, TN (US); Paul Blakney Lawrence, Kingsport, TN (US); Dale Edwin Mathis, Kingsport, TN (US)

Correspondence Address: Steven A. Owen;Eastman Chemical Company, P.O. Box 511, Kingsport, TN, 37662-5075, US

(21) Appl. No.: 11/121,625

(22) Filed: May 4, 2005

Related U.S. Application Data
(63) Continuation-in-part of application No. 10/337,496, filed on Jan. 7, 2003.

(51) Int. Cl. B05D 3/02; C11D 17/00

(52) U.S. Cl. 427/385.5

(57) ABSTRACT

This invention provides a process for the topical use of an ethoxylated alkyl phosphate ester additive on a cellulose acetate tow band as a plugmaker processing aid. This invention also provides a composition comprising an ethoxylated alkyl phosphate ester additive and cellulose acetate fibers.

### CROSS REFERENCE TO RELATED APPLICATION

This application is a continuation-in-part of copending U.S. application Ser. No. 10/337,496, filed Jan. 7, 2003, hereby incorporated by reference in its entirety to the extent that it does not contradict statements herein.

### FIELD OF THE INVENTION

This invention relates to the topical use of an ethoxylated alkyl phosphate ester additive on a cellulose acetate tow band as a plugmaker processing aid. This invention also relates to a composition comprising an ethoxylated alkyl phosphate ester additive and cellulose acetate fibers.

### BACKGROUND OF THE INVENTION

The plugmaker operation transforms a bundle of cellulose acetate fibers (called a “cellulose acetate tow band”) into a cylindrical plug with the fibers forming a filter encased with a paper wrapping. Key functions of the plugmaker include the widening of the cellulose acetate tow band, deregistering of the crimped filaments, application of a plasticizer, and formation of the cylindrical plug. To accomplish these goals, the cellulose acetate tow band is processed through a number of air jets and rolls. The current invention allows the processing to occur in a more smooth and uniform manner.

The use of an ethoxylated alkyl phosphate ester additive as a plugmaker processing aid produces a clearly visible impact on the behavior of filaments as they are processed through a plugmaker. The filaments do not spread out as much from one another and their interaction with the rolls is altered. The improvements include the following. 1) significant narrowing of a cellulose acetate tow band and reduction in variability of the cellulose acetate band width. This helps to avoid impact with the guides at the exit of a plasticizer booth and results in a more uniform cellulose acetate tow band during plasticizer application; 2) reduction in the cyclic movement of the cellulose acetate tow band upon leaving the plugmaker rolls; 3) improved relaxation of the cellulose acetate tow band; 4) reduced tendency to wrap the rolls; 5) reduced variability of the pressure drop at the maximum point. 6) expanded length of the capability curve to a higher point; and 7) reduction in the formation of long filament lint.

Work with energized static bars and passive static brushes has shown that the reduction of static charge on cellulose acetate tow band in a plugmaker has the beneficial result of reducing the accumulation of broken filament pieces referred to as long filament lint. One unexpected results of the current invention was the reduction in the long filament lint, as measured by the quantitative test method described below, achieved in comparison with the static brushes despite the apparent superiority of the brushes in reducing static.

Since the static brushes recorded a much greater reduction in static forces, the expectation was that it would show a proportionally better improvement in the reduction in long filament lint. This was found to not be the case based on the quantitative long filament lint testing described in the examples given below. When ethoxylated alkyl phosphate ester additive were used, a second unexpected result was the improvement in processing the material through the plugmaker and improvements in the resulting cylindrical plug properties. The air banding jets and rolls of the plugmaker are purposely designed to forcibly control the position and movement of the cellulose acetate tow band through the plugmaker and involves considerable tensioning of the filaments. In light of the strong forces operating on the cellulose acetate tow band from the plugmaker, it was unexpected that a modest change in finish formulation would dramatically change the behavior of the cellulose acetate tow band. In general, it was not known or suspected that the composition of materials at the surface of the fibers could have the major impact on filament behavior that was observed in this invention. Both static and frictional forces may be affected by the use of an ethoxylated alkyl phosphate ester additive.

### BRIEF SUMMARY OF THE INVENTION

The topical use of an ethoxylated alkyl phosphate ester additive on cellulose acetate tow band as a plugmaker processing aid. The ethoxylated alkyl phosphate ester additive comprises at least one ethoxylated alkyl phosphate ester with a chemical formula of [CH₃(CH₂)ₘ—O—(CH₂CH₂O)ₙ—PO₃)]⁻X⁺. The term, ethoxylated alkyl phosphate ester (EAPE), used in this invention, is a class of surfactant materials known to be useful as emulsifiers, detergents, and antistatic agents. The ethoxylated alkyl phosphate esters (EAPEs) included in the scope of this invention have an alkyl chain between C₈-C₂₂ (m=7-21) and an average degree of ethoxylation ranging from 2-30 moles of ethoxylation per mole of alkyl chain (n=2-30). These ethoxylated alkyl phosphate esters may be left as the free phosphate (X═H), but they are typically neutralized with a Group 1A metal hydroxide, forming a phosphate salt (X═Na, K). These ethoxylated alkyl phosphate esters additives are typically solubilized in water for ease of handling.

In one embodiment of this invention, a composition is provided comprising cellulose acetate fiber and an ethoxylated alkyl phosphate ester additive wherein said ethoxylated alkyl ester additive comprises at least one ethoxylated alkyl phosphate ester with a chemical formula of [CH₃(CH₂)ₘ—O—(CH₂CH₂O)ₙ—PO₃)]⁻X⁺ wherein m ranges from 7 to 21 and n ranges from 2 to 30 and X is selected from the group consisting of Na, K and H.

In another embodiment of this invention, a composition is provided comprising cellulose acetate fiber and ethoxylated alkyl phosphate ester additive wherein said ethoxylated phosphate alkyl ester additive comprises at least one ethoxylated alkyl phosphate ester with a chemical formula of [CH₃(CH₂)ₘ—O—(CH₂CH₂O)ₙ—PO₃)]⁻X⁺ wherein m ranges from 11 to 13 and n ranges from 4 to 12 and X is selected from the group consisting of Na, K and H.

In yet another embodiment of this invention, a composition is provided comprising cellulose acetate fiber and ethoxylated alkyl phosphate ester additive wherein said ethoxylated alkyl phosphate ester additive comprises poly(oxy-1,2-ethanediyl),a-tridecyl-w-hydroxy-, phosphate, potassium salt wherein said ethoxylated alkyl phosphate ester additive has a composition of 100 to 3000 ppm by weight.

In yet another embodiment of this invention, a process is provided to use an ethoxylated alky phosphate ester additive as a plugmaker processing aid comprising applying said ethoxylated alkyl phosphate ester additive on a cellulose acetate tow band wherein said ethoxylated alkyl phosphate ester additive comprises at least one ethoxylated alkyl phosphate ester with a chemical formula of [CH₃(CH₂)ₘ—O—(CH₂CH₂O)ₙ—PO₃)]—X⁺ wherein m ranges from 7 to 21 and n ranges from 2 to 30 and X is selected from the group consisting of Na, K and H.

In yet another embodiment of this invention, a process is provided to use a ethoxylated alky phosphate ester additive as a plugmaker processing aid comprising applying said ethoxylated alkyl phosphate ester additive on a cellulose acetate tow band wherein said ethoxylated alkyl phosphate ester additive comprises at least one ethoxylated alkyl phosphate ester with a chemical formula of [CH₃(CH₂)ₘ—O—(CH₂CH₂O)ₙ—PO₃)]⁻X⁺ wherein m ranges from 11 to 13 and n ranges from 4 to 12 and X is selected from the group consisting of Na, K and H.

In yet another embodiment of this invention, a process is provided to use an ethoxylated alky phosphate ester additive as a plugmaker processing aid comprising applying said ethoxylated alkyl phosphate ester additive on a cellulose acetate tow band wherein said ethoxylated alkyl phosphate ester additive comprises poly(oxy-1,2-ethanediyl),a-tridecyl-w-hydroxy-, phosphate, potassium salt wherein said ethoxylated alkyl phosphate ester additive is applied to said cellulose acetate tow band in and amount in a range of 100 to 3000 ppm by weight.

These objects, and other objects, will become more apparent to others with ordinary skill in the art after reading this disclosure.

### DETAILED DESCRIPTION

The invention provides a process comprising applying an ethoxylated alkyl phosphate ester additive onto the surface of a cellulose acetate tow band for use as a plugmaker processing aid. This invention also relates to a composition comprising an ethoxylated alkyl phosphate ester additive and cellulose acetate fibers.

The ethoxylated alkyl phosphate ester additive comprises at least one ethoxylated alkyl phosphate ester with a chemical formula of [CH₃(CH₂)ₘ—O—(CH₂CH₂O)ₙ—PO₃)]⁻X⁺. The term ethoxylated alkyl phosphate ester (EAPE) is a class of surfactant materials known to be useful as emulsifiers, detergents, and antistatic agents. The ethoxylated alkyl phosphate esters (EAPEs) included in the scope of this invention report have an alkyl chain between C₈-C₂₂ (m=7-21) and an average degree of ethoxylation ranging from 2-30 moles of ethoxylation per mole of alkyl chain (n=2-30). Preferably, the ethoxylated alkyl phosphate ester has an alkyl chain between C₁₂-C₁₄ (m=11-13) an average degree of ethoxylation per mole of alkyl chain (n=4-12).

Most preferably, the ethoxylated alkyl phosphate ester is ethoxylated potassium tridecyl phosphate ester. The chemical abstract (CA) index name for ethoxylated potassium tridecyl phosphate ester is poly(oxy-1,2-ethanediyl), a-tridecyl-w-hydroxy-,phosphate, potassium salt, and its CA registry number is 68186-36-7. Ethoxylated potassium tridecyl phosphate ester is typically 88% active with the remainder being water. The average degree of ethoxylation is 6 moles of ethoxylation per mole of tridecyl potassium. Another range for the ethoxylated alkyl phosphate ester that can be used and mixtures thereof is where m=7, 8, 9, 10, 11, 12, 13, 14, 15, 16, 17, 18, 19, 20, 21 and n=2, 3, 4, 5, 6, 7, 8, 9, 10, 11, 12, 13, 14, 15, 16, 17, 18, 19, 20, 21, 22, 23, 24, 25, 26, 27, 28, 29, 30 where m and n can be in any combination or mixture thereof. These ethoxylated alkyl phosphate esters may be left as the free phosphate (X═H), but they are typically neutralized with a Group 1A metal hydroxide forming a phosphate salt (X═Na, K). However any metal compound capable of neutralizing the ethoxylated alkyl phosphate ester and forming a phosphate salt may be used.

These ethoxylated alkyl phosphate esters are typically solubilized in water for ease of handling. The preferred composition of the ethoxylated alkyl phosphate ester for use in this invention is neutralized with KOH (X═K) and contain an alkyl chain between C₁₂-C₁₄ (m=11-13) with an average degree of ethoxylation between 4-12 moles of ethoxylation per mole of alkyl chain (n=4-12).

The objective of the topical application is to deliver the ethoxylated alkyl phosphate ester additive to the surface of the fiber on the cellulose acetate tow band. The application can be conducted by any means known in the art. Generally, the application can be completed through direct liquid application using rolls or lube tips, by use of a spray system, or by other means such that the ethoxylated alkyl phosphate ester additive resides primarily on the surface of the fibers. Application through existing fiber finishing treatments involving an oil-in-water emulsion is the preferred method of delivery. The ethoxylated alkyl phosphate ester additive on the interior of the fibers would likely provide greatly diminished benefit as a processing aid. In an embodiment of the invention, typical application levels of the ethoxylated alkyl phosphate ester additive based on the dry fiber weight would be optimally 250 to 1000 ppm by weight. In another embodiment of the invention, another range would be 100 to 3000 ppm by weight. Minimal benefit would be expected at ethoxylated alkyl phosphate ester additive levels below 10 ppm. Loading levels above 5000 ppm would still deliver the benefits of the current invention, but with minimal additional benefit.

In an embodiment of the invention, the application of the ethoxylated alkyl phosphate ester additive is through means of an oil-in-water emulsion. An emulsion is a stable mixture of 2 or more immiscible liquids held in suspension by small percentages of substances called emulsifiers and, specifically, an oil-in-water emulsion is an emulsion in which water is the continuous phase and a water-immiscible substance is the disperse phase. The word, “oil” is applied to a wide range of substances that are quite different in chemical nature from animal and vegetable oils to essential oils. Animal and vegetable oils are composed largely of glycerides of fatty acids; mineral oils are composed of hydrocarbon mixtures, and essential oils are principally volatile terpenes. The mineral oil used in the current invention is meant to denote a paraffinic distillate of petroleum composed primarily of straight chain hydrocarbons. The preferred application method in the current invention is by means of an oil-in-water emulsion comprised of an emulsified mineral oil (paraffinic distillate of petroleum) with the addition of the ethoxylated alkyl phosphate ester additive described in the current invention at the levels delineated in the current application.

In other embodiments of the invention, the cellulose acetate fiber does not have a super absorbent polymer in each of the embodiments previously mentioned.

In another embodiment of the invention, the cellulose acetate fiber is without groves in all the previous embodiments.

This invention can be further illustrated by the following examples of preferred embodiments thereof, although it will be understood that these examples are included merely for purposes of illustration and are not intended to limit the scope of the invention unless otherwise specifically indicated.

### EXAMPLES

An ethoxylated alkyl phosphate ester additive was added to a standard formulation of acetate tow finish. Aqueous oil-in-water emulsions were produced with ethoxylated alkyl phosphate ester additive levels that would deliver approximately 0, 250, and 500 ppm by weight of ethoxylated alkyl phosphate ester additive based on dry fiber weight. No problems were noted with emulsion stability.

A total of fourteen samples of cellulose acetate tow band were produced as shown in Table 1 using the different finishes described above. Operating conditions for the manufacture of the cellulose acetate tow band were held constant except for the change in finish. The finish was applied directly to the filaments upon exit from the spinning cabinets. Analytical measurements on the cellulose acetate tow band samples after crimping verified that the targeted levels of finish were successfully applied to the cellulose acetate tow band.

A variety of tests were performed with the samples using a Hauni® AF3 and Hauni® AF2 plugmakers. The Hauni® AF3 was operated at 600 meters/minutes while the Hauni® AF2 ran at 400 meters/minute. The differences observed in performance due to the treatment level was much more apparent at the higher operating speeds so the experimental testing performed on the Hauni® AF3 is described in this example. The need for a processing aid such as ethoxylated alkyl phosphate ester additive appears to be greatest in machines that operate at higher speeds.

The experiment was performed on the Hauni® AF3 plugmaker both with and without passive static brushes. A static brush contains a rectangular arrangement of grounded conductive bristles that are suspended near the cellulose acetate tow band for the purpose of dissipating static charge. The first static brush was mounted between the pretension roll and the slow threaded roll. The static brushes are mounted relatively far away from the nip of the rolls to avoid contact of the brush bristles with either the rolls or the cellulose acetate tow band. The second static brush was mounted between the slow threaded roll and the fast threaded roll.

The summary statistics of the experimental runs listed in Table 1 are summarized in Table 2 to show more clearly the impact due to ethoxylated alkyl phosphate ester additive treatment level for the two brush configurations. Static charge was measured above the center of the cellulose acetate tow band at the exit of the plasticizer booth. The use of 250 ppm ethoxylated alkyl phosphate ester additive reduced the static charge 13.7 K-volts representing a significant change. Doubling the addition to 500 ppm brought an additional reduction of 5.8 K-volts indicating that a point of diminishing impact was being approached. The use of static brushes reduces the static measure by 27.1 K-volts regardless of the ethoxylated alkyl phosphate ester additive treatment level.

Long filament lint accumulation involves the collection of broken filaments at various locations in the plugmaker with lengths ranging from approximately 0.25 to 30 centimeters in length. Problems associated with long filament lint include: sudden release of a clump of filaments from a collection point leading to a rod quality defect or a machine breakdown; machine breakdowns due to roll wraps; and increased housekeeping work required to keep the instrument clean. A subjective rating scale is used in which the plugmaker operator observes the accumulation of filaments on machine surfaces at the exit of the plasticizer booth over a fixed time. The best score corresponding to very low long filament lint is given a value of 1 while higher values up to a score of 10 indicate progressively larger amounts of lint.

The use of 250 ppm be weight ethoxylated alkyl phosphate ester additive reduced the long filament lint by 1.1 units representing a significant change. The use of 500 ppm by weight ethoxylated alkyl phosphate ester additive reduced the long filament lint by 1.6 units relative to the control. The use of static brushes reduced the rating by 1.9 units for all ethoxylated alkyl phosphate ester additive treatment levels.

A second measure of long filament lint involved a quantitative measure obtained by taking electronic images of the plugmaker surfaces at regular intervals throughout the lint test. Image analysis was performed to quantify the rate at which long filament lint collected on the machine. This quantitative measure provides a more objective and thorough measure of long filament lint. The use of 250 ppm ethoxylated alkyl phosphate ester additive reduced the quantitative rate of long filament lint accumulation from 5982 to 4132. The use of 500 ppm ethoxylated alkyl phosphate ester additive reduced the same value to 3621 representing a 39% reduction. The average level of quantitative long filament lint was 3877 in the presence of the ethoxylated alkyl phosphate ester additive.

The static brushes at 0 ppm ethoxylated alkyl phosphate ester additive reduced this value from 5982 to 4526. The average level of quantitative long filament lint was 3634 when static brushes were used in the presence of ethoxylated alkyl phosphate ester additive. The reduction in long filament lint in the presence of the ethoxylated alkyl phosphate ester additive was roughly the same regardless of whether the static brushes were present (3877 versus 3634). The magnitude of the improvement in long filament lint was greater with the ethoxylated alkyl phosphate ester additive than with static brushes alone despite the fact that the static brushes had a much greater impact on the static readings (3877 versus 4526). This provides some evidence that the static in the region of the nips is an important factor. It also points to the possibility that other mechanisms of impacting filament and cellulose acetate tow band behavior may be present such as those due to fiber-roll friction.

It is hypothesized that static charge leads to forces that act on the filaments to extend outside the cellulose acetate tow band and interact with the various plugmaker surfaces. Interaction with the rolls is likely to be an especially strong factor in causing filaments to extend beyond the plane of the cellulose acetate tow band. Filaments extending from the cellulose acetate tow band can easily break when impacting plugmaker surfaces or plasticizer leading to the formation of long filament lint.

Several qualitative observations were made identifying improvements in cellulose acetate tow band behavior resulting from the use of the ethoxylated alkyl phosphate ester additive as a processing aid. One effect was a narrowing and steadying of the cellulose acetate tow band width. The cellulose acetate tow band width of the runs at 0 ppm ethoxylated alkyl phosphate ester additive tended to fluctuate over time often impacting the guides at the exit of the plasticizer booth that are about 12 inches apart. The cellulose acetate tow band narrowed by several inches at 250 and 500 ppm and the cellulose acetate tow band's width became quite steady. Part of the visual lint improvement mentioned earlier is due to the cellulose acetate tow band no longer impacting the guides that commonly serve as long filament lint accumulation spots. An additional processing advantage is that the plasticizer application uniformity is likely improved by the consistent cellulose acetate tow band behavior through the plasticizer spraying operation.

A second key change in cellulose acetate tow band behavior that represents a processing improvement involves the interaction of the cellulose acetate tow band with the plugmaker rolls. The Hauni® AF3 plugmaker has four sets of rolls from beginning to end: pretension, slow threaded, fast threaded, and delivery rolls. At the 0 ppm ethoxylated alkyl phosphate ester additive treatment level, the cellulose acetate tow band can be observed to cycle in and out of the main plane defined by the passage of the cellulose acetate tow band through the plugmaker. As the cellulose acetate tow band emerges from the nip formed by the two rotating rolls, a tendency exists for the cellulose acetate tow band to remain touching or near one of the rolls. This pulls the cellulose acetate tow band outside the main plane mentioned earlier. Eventually, the downstream rolls exert forces on the cellulose acetate tow band that separate the cellulose acetate tow band that had emerged from the nip from the rolls. The appearance of this phenomenon can be summarized by saying the cellulose acetate tow band is flopping back and forth. Floppiness is undesirable since it involves nonuniform application of forces along the cellulose acetate tow band that will lead to differences in the removal of crimp from the cellulose acetate tow band. Following the fast threaded roll, an important process called relaxation must occur in which the fiber must reform crimp that has been temporarily removed through extensions by the rolls. The cyclic movement described earlier is likely to change the short term relaxation achieved leading to plug variability.

One of the most severe plugmaker processing situations involving this interaction of cellulose acetate tow bands and rolls involves a roll wrap that inevitably leads to a machine breakdown. In a roll wrap, the interaction of the cellulose acetate tow band and roll is not overcome by the downstream pulling on the cellulose acetate tow band. Instead, the cellulose acetate tow band continues attached to the roll for multiple revolutions. The interaction of cellulose acetate tow bands with the rolls in a plugmaker is complex involving several different types of forces. One important force involves air pressure differences induced by the moving rolls.

A second force involves the generation of static electrical charge due to the contact and subsequent separation of the rolls and fiber. As oppositely charged surfaces begin to separate, an electric field forms involving forces that act to prevent separation. Based on the static charge measurements described earlier, it is likely that this mechanism is one of the factors contributing to the efficacy of ethoxylated alkyl phosphate ester additive.

A third set of forces involves frictional forces between the rolls and cellulose acetate tow band. The formulation of a fiber finish, both the amount and chemical species present, have a dramatic impact on the frictional forces of the treated fiber. It is possible that ethoxylated alkyl phosphate ester additive impacts the frictional behavior of the cellulose acetate tow band thereby impacting its behavior with the rolls. The overall smoother movement of the cellulose acetate tow band through the plugmaker may offer the advantage of a longer capability curve and lower variation in the pressure drop at the maximum point. The maximum point is defined in part by the operating point beyond which the plugmaker consistently breaks down when adjustments are made to further increase the amount of tow in a plug per unit length. It is likely that the advantages of ethoxylated alkyl phosphate ester additive described above will extend this operating point. The data in Table 2 indicates that the pressure drop coefficient of variation appears to have improved about 12% due to ethoxylated alkyl phosphate ester additive treatment.

TABLE 1
Experimental results by individual runs for testing performed on the Hauni ® AF3 plugmaker.

| | Ethoxylated | | | | | | |
|---|---|---|---|---|---|---|---|
| | alkyl | | | | | | |
| | phosphate | | | | Maximum Point | | |
| | ester | | Long Filament Lint | | | Pressure | |
| | additive | Static | Accumulation | | | Drop | |
| Example # | Treatment | Brush on | (Subjective | | | Coefficient | Static |
| (Bale ID) | Level | Plugmaker | Rating, 1 = Best | (Quantitative | Pressure | of Variation | Charge |
| (#) | (ppm) | (yes or no) | to 10 = Worst) | Rating) | Drop (mm) | (%) | (K-volts) |
| 462 | 0 | No | 5 | 7454 | 425.9 | 4.14 | 30.3 |
| 462 | 0 | No | 4 | 9207 | | | 31 |
| 467 | 0 | No | 4 | 7229 | | | 27.9 |
| 467 | 0 | No | 5 | 3553 | | | 32.7 |
| 469 | 0 | No | 4 | 5106 | 440.4 | 3.29 | 31.2 |
| 469 | 0 | No | 5 | 9270 | | | 31.7 |
| 498 | 0 | No | 5 | 6430 | 440.2 | 3.98 | 31.8 |
| 498 | 0 | No | 4 | 5541 | | | 31.4 |
| 500 | 0 | No | 3 | 3840 | 414.2 | 3.59 | 31.2 |
| 500 | 0 | No | 3 | 3841 | | | 32.3 |
| 503 | 0 | No | 2 | 5922 | | | 32.2 |
| 503 | 0 | No | 4 | 4386 | 450 | 3.00 | 29.8 |
| 463U | 250 | No | 3 | 3848 | 448.7 | 3.68 | 13.7 |
| 468U | 250 | No | 4 | 5784 | | | 18 |
| 499U | 250 | No | 2 | 2414 | 460.5 | 2.87 | 16.3 |
| 504U | 250 | No | 2 | 4484 | 426.5 | 2.89 | 21.6 |
| 468L | 500 | No | 2 | 3066 | | | 6.5 |
| 468L | 500 | No | 2 | 3394 | 440.2 | 2.68 | 12.2 |
| 499L | 500 | No | 3 | 3765 | 410.1 | 3.70 | 12.1 |
| 504L | 500 | No | 2 | 4258 | | | 15.5 |
| 462 | 0 | Yes | 2 | 5020 | | | 3 |
| 467 | 0 | Yes | 1 | 3005 | | | 5.9 |
| 469 | 0 | Yes | 3 | 5819 | | | 3.4 |
| 498 | 0 | Yes | 3 | 7539 | | | 4.6 |
| 500 | 0 | Yes | 2 | 2619 | | | 1.8 |
| 503 | 0 | Yes | 1 | 3153 | | | 4.7 |
| 463U | 250 | Yes | 2 | 3927 | | | 3.9 |
| 499U | 250 | Yes | 2 | 2283 | | | 4.2 |
| 468L | 500 | Yes | 2 | 3119 | | | 3.8 |
| 499L | 500 | Yes | 2 | 5207 | | | 4.1 |

TABLE 2
Experimental results summarized by ethoxylated alkyl phosphate ester additive treatment
level and the use of static brushes for testing performed on the Hauni ® AF3 plugmaker.

| Ethoxylated | | | | | | | | | | | |
|---|---|---|---|---|---|---|---|---|---|---|---|
| alkyl | | Long Filament Lint | | | | | | | | | |
| phosphate | | Accumulation | | | | Maximum Point | | | | | |
| ester | | (Subjective | | | | | | Pressure Drop | | Static | |
| additive | Static | Rating, 1 = Best | | (Quantitative | | Pressure Drop | | Coefficient of | | Charge | |
| Treatment | Brush on | to 10 = Worst) | | Rating) | | (mm) | | Variation (%) | | (K-volts) | |
| Level | Plugmaker | | Std. | | Std. | | Std. | | Std. | | Std. |
| (ppm) | (yes or no) | Mean | Dev. | Mean | Dev. | Mean | Dev. | Mean | Dev. | Mean | Dev. |
| 0 | No | 4.0 | 1.0 | 5982 | 1993.8 | 434 | 14.1 | 3.6 | 0.5 | 31.1 | 1.3 |
| 250 | No | 2.8 | 1.0 | 4132 | 1400.9 | 445 | 17.3 | 3.1 | 0.5 | 17.4 | 3.3 |
| 500 | No | 2.3 | 0.5 | 3621 | 511.7 | 425 | 21.3 | 3.2 | 0.7 | 11.6 | 3.7 |
| 0 | Yes | 2.0 | 0.9 | 4526 | 1940.7 | | | | | 3.9 | 1.5 |
| 250 | Yes | 2.0 | 0.0 | 3105 | 1162.7 | | | | | 4.1 | 0.2 |
| 500 | Yes | 2.0 | 0.0 | 4163 | 1476.7 | | | | | 4.0 | 0.2 |

1. A composition comprising cellulose acetate fiber and an oil-in-water emulsion comprising an ethoxylated alkyl phosphate ester additive wherein said ethoxylated alkyl phosphate ester additive comprises at least one ethoxylated alkyl phosphate ester with a chemical formula of [CH₃(CH₂)ₘ—O—(CH₂CH₂O)ₙ—PO₃)]⁻X⁺ wherein m ranges from 7 to 21 and n ranges from 2 to 30 and X is selected from the group consisting of Na, K and H, and wherein said oil-in-water emulsion comprises mineral oil.

2. A composition according to claim 1 wherein said ethoxylated alkyl phosphate ester additive is present in said composition in an amount ranging from about 100 ppm to about 3000 ppm by weight.

3. A composition according to claim 1 wherein said ethoxylated alkyl phosphate ester additive is present in said composition in an amount ranging from about 250 ppm to about 1000 ppm by weight.

4. A composition comprising cellulose acetate fiber and an oil-in-water emulsion comprising an ethoxylated alkyl phosphate ester additive wherein said ethoxylated alkyl phosphate ester additive comprises at least one ethoxylated alkyl phosphate ester with a chemical formula of [CH₃(CH₂)ₘ—O—(CH₂CH₂O)ₙ—PO₃)]⁻X⁺ wherein m ranges from 11 to 13 and n ranges from 4 to 12 and X is selected from the group consisting of Na, K and H wherein said oil-in-water emulsion comprises mineral oil.

5. A composition according to claim 4 wherein said ethoxylated alkyl phosphate ester additive is present in said composition in an amount ranging from about 100 ppm to about 3000 ppm by weight.

6. A composition according to claim 4 wherein said ethoxylated alkyl phosphate ester additive is present in said composition in an amount ranging from about 250 ppm to about 1000 ppm by weight.

7. A composition according to claim 4 wherein said ethoxylated alkyl phosphate ester is poly(oxy-1,2-ethanediyl),a-tridecyl-w-hydroxy-, phosphate, potassium salt.

8. A composition according to claim 7 wherein said ethoxylated alkyl phosphate ester additive is present in said composition in an amount ranging from about 100 ppm to about 3000 ppm by weight.

9. A composition according to claim 7 wherein said ethoxylated alkyl phosphate ester additive is present in said composition in an amount ranging from about 250 ppm to about 1000 ppm by weight.

10. A composition comprising cellulose acetate fiber and an oil-in-water emulsion comprising an ethoxylated alkyl phosphate ester additive wherein said ethoxylated alkyl ester additive comprises poly(oxy-1,2-ethanediyl), a-tridecyl-w-hydroxy-, phosphate, potassium salt wherein said ethoxylated alkyl phosphate ester additive is present in said composition in an amount ranging from 100 to 3000 ppm by weight, and wherein said oil-in-water emulsion comprises mineral oil.
